(19) United States
(12) Patent Application Publication
(10) Pub. No.: US 2026/0015202 A1
(43) Pub. Date: Jan. 15, 2026

(54) ELEVATOR BRAKE

(71) Applicant: Otis Elevator Company, Farmington, CT (US)

(72) Inventor: Juan Antonio Illan, Madrid (ES)

(21) Appl. No.: 19/259,664

(22) Filed: Jul. 3, 2025

(30) Foreign Application Priority Data
Jul. 15, 2024 (EP) 24382763.1

(51) Int. Cl. B66B 1/36; B66B 5/02

(52) U.S. Cl. CPC B66B 1/36; B66B 5/02

(57) ABSTRACT

An elevator brake for braking rotation of a shaft includes a brake disc mounted to the shaft such as to rotate with the shaft; at least two movable plungers that are movable along the axial direction (A) for engaging the elevator brake or releasing the elevator brake; and an actuator, including at least two springs configured for applying a spring force to at least one of the at least two movable plungers for urging the at least one movable plunger towards the brake disc for engaging the elevator brake; and at least one solenoid configured for producing a counterforce directed against the spring forces applied by the springs such as to urge the movable plungers in the axial direction (A) away from the brake disc for releasing the elevator brake. The at least two springs are arranged in series with each other along the axial direction (A).

### FOREIGN PRIORITY

This application claims priority to European Patent Application No. 24382763.1, filed Jul. 15, 2024, and all the benefits accruing therefrom under 35 U.S.C. § 119, the contents of which in its entirety are herein incorporated by reference.

### TECHNICAL FIELD OF INVENTION

The invention relates to an elevator brake. The invention further relates to an elevator drive system and to an elevator system comprising at least one elevator brake, respectively.

### BACKGROUND OF THE INVENTION

An elevator system typically comprises at least one elevator car configured for moving along a hoistway extending between a plurality of landings, and a drive system configured for driving the elevator car.

The drive system comprises at least one motor for moving the elevator car along the hoistway, and at least one elevator brake for braking and stopping the movement of the elevator car.

The at least one elevator brake may comprise a brake disc and at least one movable plunger, wherein the at least one movable plunger is movable into frictional engagement with the brake disc for selectively braking and stopping any rotation of the brake disc. In order to allow reliably braking and stopping any movement of the elevator car even in case one of the movable plungers should not be able to move due to a malfunction, a typical elevator brake comprises at least two movable plungers that are movable independently of each other. Elevator safety codes typically require that an elevator safety brake comprises at least two movable plungers.

Providing an elevator brake with two movable plungers may result in hard stops of the elevator car when both movable plungers are simultaneously moved into engagement with the brake disc. Such hard stops may be unpleasant and even dangerous for passengers within the elevator car.

It would therefore be beneficial to provide an improved elevator brake that allows for preventing hard stops of the elevator car without deteriorating the safety of the elevator brake.

### SUMMARY OF THE INVENTION

According to an exemplary embodiment of the invention, an elevator brake for braking rotation of a shaft extending along an axial direction in an elevator drive is provided. The shaft is rotatable around an axis of rotation extending along the axial direction, and the elevator brake comprises: at least one brake disc mounted to the shaft such as to rotate concurrently with the shaft; at least two movable plungers that are movable along the axial direction for selectively engaging or releasing the elevator brake; and an actuator. The actuator comprises at least two springs and at least one solenoid. Each of the at least two springs is configured for applying a spring force to at least one of the at least two movable plungers for urging the at least one movable plunger towards the at least one brake disc in order to engage the elevator brake. The at least one solenoid is configured for producing a counterforce directed against the spring forces applied by the springs such as to urge the at least one movable plunger in the axial direction away from the at least one brake disc for releasing the elevator brake. The at least two springs are arranged and coupled serially to each other along the axial direction.

Exemplary embodiments of the invention also include an elevator drive system comprising a rotatable shaft, a motor configured for rotating the shaft, and an elevator brake according to an exemplary embodiment of the invention that is configured for braking and stopping rotation of the shaft.

Exemplary embodiments of the invention further include an elevator system comprising an elevator car that is movable in a hoistway between a plurality of landings and an elevator drive system according to an exemplary embodiment of the invention that is configured for moving the elevator car along the hoistway.

The at least two movable plungers of an elevator brake according to an exemplary embodiment of the invention are movable independent of each other for providing the required redundancy and enhancing the reliability of the elevator brake.

In an elevator brake according to an exemplary embodiment of the invention, braking forces that are sufficiently strong for reliably braking rotation of the brake disc and of the shaft for stopping any movement of an elevator car coupled to the shaft may be provided even in situations in which one of the at least two movable plungers is not movable into engagement.

Since the at least two springs are arranged and coupled in a serial configuration with each other along the axial direction, a relatively soft stop of the elevator car may be achieved. In particular, an unpleasant or even dangerous hard emergency stop of the elevator car may be prevented even in a situation in which all movable plungers are simultaneously moved into engagement by the at least two springs.

In the following, a number of optional features of an elevator brake according to exemplary embodiments of the invention are set out. These features may be realized in particular embodiments, alone or in combination with any of the other features, unless explicitly stated otherwise.

The elevator brake may comprise at least one longitudinal support member extending parallel to the shaft. At least one of the at least two movable plungers may be movably supported by the at least one longitudinal support member. In particular, all movable plungers may be movably supported by the at least one longitudinal support member.

The elevator brake may comprise a single longitudinal support member or a plurality of longitudinal support members extending parallel to each other.

A longitudinal support member provides a convenient and reliable element for movably supporting at least one of the at least two movable plungers in a configuration in which it is movable along the axial direction.

The elevator brake may comprise a first stationary element that is not rotating together with the shaft. Such a first stationary element may in particular be a stationary braking element that is configured for engaging with the brake disc or, more particularly, for engaging with a brake lining applied to the brake disc for braking and stopping rotation of the brake disc.

The elevator brake may further comprise a second stationary element that is not rotating with the shaft. The second stationary element may provide a support for supporting the at least one longitudinal element. The second stationary element may further support at least one of the at least two springs in the axial direction. This may allow the at least one of the at least two springs to push at least one of the at least two movable plungers into engagement with the brake disc.

The at least one movable plunger and the first stationary element may form a brake saddle that is configured for engaging with the brake disc sandwiched between the at least one movable plunger and the first stationary element.

The at least one brake disc, the at least two movable plungers and the actuator with the at least two springs and the at least one solenoid may be arranged in between the first stationary element and the second stationary element along the axial direction. Such a configuration may allow the actuator to be supported by the second stationary element along the axial direction when it pushes at least one of the at least two movable plungers into engagement with the brake disc.

The elevator brake may comprise a single brake disc, a first movable plunger and a second movable plunger. The brake disc may in particular be interposed between the first stationary element and the first movable plunger.

The first movable plunger may be configured for frictionally engaging with the brake disc, in particular with a brake lining applied to the brake disc, urging the brake disc towards the first stationary element for frictionally engaging the brake disc with the first stationary element. This frictional engagement may produce a braking force braking rotation of the brake disc according to the frictional engagement.

The second movable plunger may comprise an extension extending in the axial direction from the second movable plunger towards the brake disc. The first movable plunger may be supported by the extension such as to be movable along the axial direction with respect to the second movable plunger. In such a configuration the second movable plunger is movably supported by the second movable plunger and the first movable plunger is movable at least concurrently with the second movable plunger. This may reliably prevent the first movable plunger from blocking movement of the second movable plunger along the axial direction. Since the first movable plunger is movably supported by the second movable plunger, the first movable plunger may additionally move with respect to the second movable plunger in normal operation.

The at least two springs may comprise a first spring that is configured for exerting a spring force urging the first movable plunger along the axial direction towards the brake disc.

The actuator may comprise at least two solenoids. Each solenoid may be associated with a respective one of the at least two springs and configured for producing a counterforce directed against the respective spring force applied by the respectively associated spring for releasing the elevator brake by urging the at least one movable plunger in the axial direction away from the at least one brake disc.

The at least two solenoids may comprise a first solenoid that is associated with the first spring and configured for producing a counterforce directed against the spring force exerted by the first spring along the axial direction for attracting the first movable plunger towards the second movable plunger. Such a configuration allows moving the first movable plunger towards the second movable plunger by activating the first solenoid.

The first spring and the first solenoid may be accommodated in or attached to the first movable plunger and/or the second movable plunger.

The at least two springs may further comprise a second spring that is configured for exerting a spring force urging the second movable plunger along the axial direction away from the second stationary element towards the brake disc for engaging the brake. Moving the second movable plunger towards the brake disc may in particular urge the first movable plunger, which may be arranged between the second movable plunger and the brake disc, along the axial direction into engagement with the brake disc for braking rotation of the brake disc.

The at least two solenoids may further comprise a second solenoid that is associated with the second spring and configured for producing a counterforce directed against the spring force exerted by the second spring for attracting the second movable plunger towards the second stationary element and away from the brake disc.

The second spring and the second solenoid may be accommodated in the second movable plunger and/or in the second stationary element.

For releasing the elevator brake, the first movable plunger may be moved out of engagement with the brake disc by activating the at least one solenoid.

When the at least one solenoid is activated, the magnetic force generated by the at least one solenoid moves the first movable plunger away from the brake disc towards the second movable plunger and/or the second movable plunger away from the brake disc towards the second stationary element.

In an embodiment comprising two solenoids, the magnetic force generated by the first solenoid moves the first movable plunger away from the brake disc towards the second movable plunger and the magnetic force generated by the second solenoid moves the second movable plunger away from the brake disc towards the second stationary element when the first and second solenoid are both activated.

### BRIEF DESCRIPTION OF THE DRAWINGS

In the following, exemplary embodiments of the invention are described in more detail with respect to the enclosed figures:

FIG. 1 depicts a schematic view of an elevator system according to an exemplary embodiment of the invention.

FIG. 2 depicts a schematic view of an elevator brake according to an exemplary embodiment of the invention.

FIG. 3 shows the elevator brake in a released state.

FIG. 4 illustrates the elevator brake in a first engaged state.

FIG. 5 illustrates the elevator brake in a second engaged state.

FIG. 6 illustrates the elevator brake in a third engaged state.

FIG. 7 depicts a schematic view of an elevator brake according to another exemplary embodiment of the invention.

FIG. 8 depicts a schematic view of an elevator brake according to yet another exemplary embodiment of the invention.

### DETAILED DESCRIPTION OF THE INVENTION

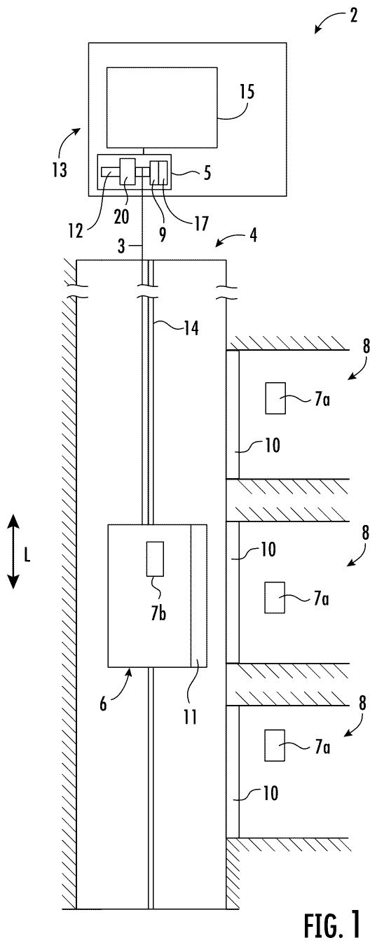

FIG. 1 schematically depicts an elevator system 2 according to an exemplary embodiment of the invention.

The elevator system 2 comprises a hoistway 4 extending in a longitudinal direction L between a plurality of landings 8 located on different floors. The elevator system 2 includes an elevator car 6 arranged within the hoistway 4 for being moved along the longitudinal direction L between the plurality of landings 8. The elevator car 6 may be movable along at least one elevator car guide member 14, such as at least one elevator car guide rail provided within the hoistway 4 and extending along the longitudinal direction L.

The longitudinal direction L may be oriented in a vertical direction, as it is depicted in FIG. 1. In an alternative embodiment, which is not depicted in the figures, the longitudinal direction L may be inclined with respect to the vertical direction.

Although only a single elevator car guide member 14 is visible in FIG. 1, the elevator system 2 may comprise a plurality of elevator car guide members 14.

Although only a single elevator car 6 is depicted in FIG. 1, exemplary embodiments of the invention may include elevator systems 2 comprising a plurality of elevator cars 6 moving in one or more hoistways 4.

The elevator car 6 is movably suspended by means of a tension member 3.

The tension member 3, for example a rope or belt, is coupled to an elevator drive system 5. The elevator drive system 5 comprises a motor 9 for rotatably driving a shaft 12, and a drive 17 that harnesses and controls the electrical energy supplied to the motor 9. The elevator drive system 5 is configured for driving the tension member 3 that is coupled to the shaft 12 in order to move the elevator car 6 within the hoistway 4 along the longitudinal direction L between the plurality of landings 8.

The elevator drive system 5 is further provided with at least one elevator brake 20 for braking rotation of the shaft 12 in order to allow stopping movement of the elevator car 6.

The elevator system 2 may further include an elevator counterweight, which is not depicted in FIG. 1. The elevator counterweight may be attached to the tension member 3 opposite to the elevator car 6 and configured for moving concurrently and in opposite direction with respect to the elevator car 6 along at least one elevator counterweight guide member, which is also not shown in FIG. 1.

Exemplary embodiments of the invention may be employed in elevator systems 2 comprising a counterweight and in elevator systems 2 that do not comprise an elevator counterweight.

The tension member 3 may be a rope, e.g. a steel cord, or a belt. The tension member 3 may be uncoated. Alternatively, the tension member 3 may be coated with a coating, e.g. with a coating having the form of a polymer jacket. In a particular embodiment, the tension member 3 may be a belt comprising a plurality polymer coated steel cords (not shown). The elevator system 2 may have a traction drive including a traction sheave for driving the tension member 3.

The exemplary embodiment shown in FIG. 1 uses a 1:1 roping for suspending the elevator car 6. The skilled person, however, easily understands that the type of the roping is not essential for the invention and that different kinds of roping, e.g. a 2:1 roping or a 4:1 roping may be used as well.

A landing door 10 is provided at each of the landings 8. The elevator car 6 is provided with a corresponding elevator car door 11 for allowing passengers to transfer between a landing 8 and the interior of the elevator car 6, when the elevator car 6 is positioned at the respective landing 8.

For moving the elevator car 6 along the hoistway 4 between the different landings 8, the elevator drive system 5 may be controlled by a controller 15 of the elevator system 2.

The elevator system 2 may comprise a machine room 13 housing the elevator drive system 5 and the controller 15. Alternatively, the elevator system 2 may be a machine room-less elevator system 2.

Input to the controller 15 may be provided via landing control panels 7a provided on every landing 8, in particular in the vicinity of the landing doors 10, and/or via an elevator car control panel 7b provided inside the elevator car 6.

The landing control panels 7a may comprise elevator hall call buttons and/or destination call buttons. Destination call buttons allow passengers to enter their respective destinations before entering the elevator car 6. In case the landing control panels 7a are equipped with destination call buttons, no elevator car control panel 7b needs to be provided inside the elevator car 6, since the elevator system 2 is fully controlled by the commands input via the landing control panels 7a.

The landing control panels 7a and the elevator car control panel 7b may be connected to the controller 15 by means of electrical wiring, which are not shown in FIG. 1, in particular by an electric bus, or by means of wireless data connections.

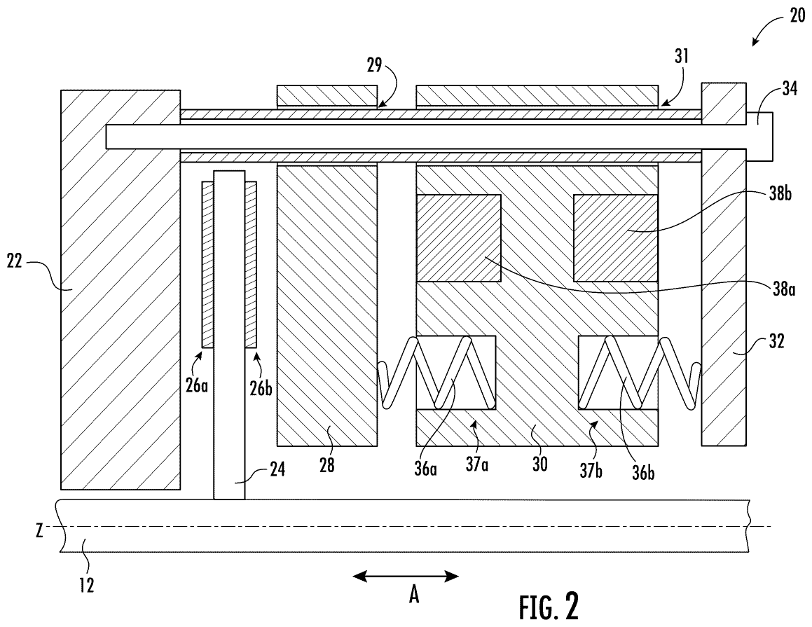

FIG. 2 depicts a schematic view of an elevator brake 20 according to an exemplary embodiment of the invention.

The elevator brake 20 comprises, in the exemplary orientation depicted in FIG. 2 from left to right: A first stationary element 22, a brake disc 24, a first movable plunger 28, a second movable plunger 30, and a second stationary element 32.

The brake disc 24 is non-rotatably coupled to the shaft 12. The shaft 12 extends in an axial direction A along an axis of rotation Z. A brake lining 26a, 26b is provided on each side of the brake disc 24, respectively.

A longitudinal support member 34 extends between the first and second stationary elements 22, 32 parallel to the shaft 12. The longitudinal support member 34 is rigidly, i.e. non-movably, fixed to the first and second stationary elements 22, 32, respectively.

The first and second movable plungers 28, 30 are supported by the longitudinal support member 34 in a configuration in which they are movable independently of each other along the longitudinal support member 34 in the axial direction A.

In the exemplary embodiment depicted in FIG. 2, the first movable plunger 28 comprises a first opening 29 extending in the axial direction A, and the second movable plunger 30 comprises a second opening 31 that also extends in the axial direction A.

The first and second openings 29, 31 are arranged coaxially with each other, with the longitudinal support member 34 extending through said openings 29, 30. As a result, each of the first and second movable plungers 28, 30 is able to slide along the longitudinal support member 34 in the axial direction A.

A first spring 36a is provided between the first movable plunger 28 and the second movable plunger 30. The first spring 36a is configured for urging the first movable plunger 28 away from the second movable plunger 30 towards the brake disc 24.

The first spring 36a may be partially arranged within a first recess 37a formed in the surface of the second movable plunger 30 facing the first movable plunger 28, as it is depicted in FIG. 2. Additionally or alternatively, the first spring 36a may be partially arranged within a similar recess (not shown) formed in the first movable plunger 28.

The second movable plunger 30 further comprises a first solenoid 38a associated with the first spring 36a and configured for producing a magnetic counterforce that is directed against the spring force applied by the first spring 36a such as to pull the first movable plunger 28 in the axial direction A away from the brake disc 24 towards the second movable plunger 30.

A second spring 36b is provided between the second movable plunger 30 and the second stationary element 32 for urging the second movable plunger 30 away from the second stationary element 32 towards the brake disc 24.

The second spring 36b may be partially arranged within a second recess 37b formed in the surface of the second movable plunger 30 facing the second stationary element 32, as it is depicted in FIG. 2. Additionally or alternatively, the second spring 36b may be partially arranged within a similar recess (not shown) formed in the second stationary element 32.

The second movable plunger 30 further comprises a second solenoid 38b associated with the second spring 36b and configured for producing a magnetic counterforce directed against the spring force applied by the second spring 36b such as to pull the second movable plunger 30 in the axial direction A towards the second stationary element 32.

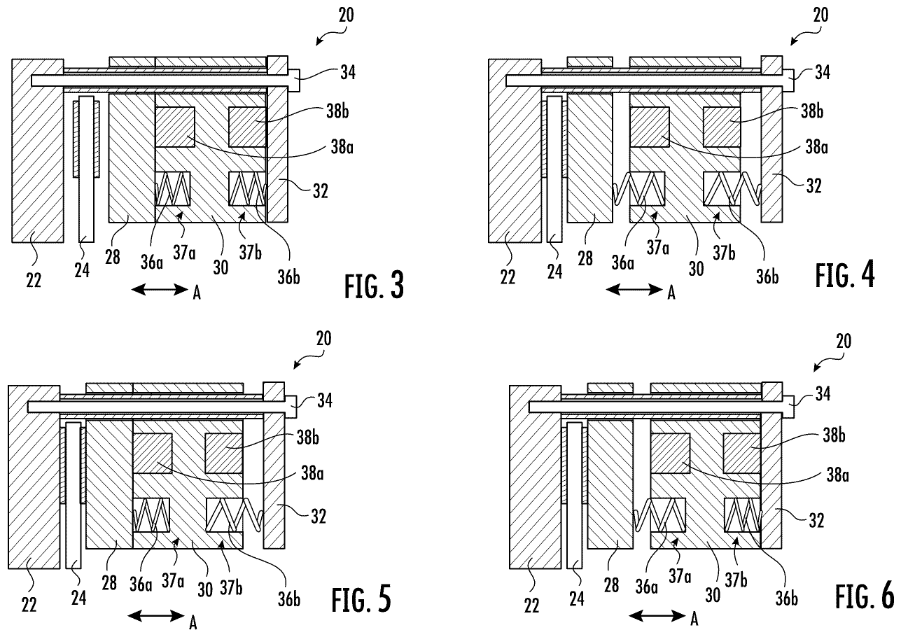

FIG. 3 illustrates a released state of the elevator brake 20.

In the released state, the first and second solenoids 38a, 38b are both activated. In consequence, the second solenoid 38b produces a magnetic counterforce that is directed against the spring force applied by the second spring 36b. The magnetic counterforce produced by the second solenoid 38b pulls the second movable plunger 30 in the axial direction A away from the brake disc 24 towards the second stationary element 32.

The first solenoid 38a produces a magnetic counterforce that is directed against the spring force applied by the first spring 36a. The magnetic counterforce produced by the first solenoid 38a pulls the first movable plunger 28 in the axial direction A away from the brake disc 24 towards the second movable plunger 30.

As a result, the first movable plunger 28 does not engage with the brake disc 24, and the brake disc 24 and the shaft 12 may rotate freely.

FIG. 4 illustrates a first engaged state of the elevator brake 20, which may be the usual state for engaging the elevator brake 20 in normal operation. FIGS. 5 and 6 illustrate engaged states in which only one of plungers 28, 30 is engaged as it occurs when one of the plungers 28, 30 is stuck.

In the first engaged state depicted in FIG. 4, both solenoids 38a, 38b are deactivated, so they do not produce any electromagnetic counterforces.

In consequence, the second spring 36b pushes the second movable plunger 30 elastically along the axial direction A away from the second stationary element 32 towards the first movable plunger 28 and the brake disc 24.

Similarly, the first spring 36a pushes the first movable plunger 28 elastically along the axial direction A away from the second movable plunger 30 towards the brake disc 24.

As a result, the brake disc 24 is sandwiched between the first stationary element 22 and the first movable plunger 28. The first stationary element 22 engages with the first brake lining 26a of the brake disc 24 and the first movable plunger 28 engages with the second brake lining 26b of the brake disc 24, thereby braking rotation of the brake disc 24 and of the shaft 12.

FIG. 5 illustrates a second engaged state of the elevator brake 20.

In the second engaged state illustrated in FIG. 5, the first movable plunger 28 did not move along the axial direction A with respect to the second movable plunger 30. The first solenoid 38a may still be activated and/or the first spring 36a may not be able to push the first movable plunger 28 away from the second movable plunger 30.

In the configuration illustrated in FIG. 5, the second movable plunger 30 is pushed away from the second stationary element 32 towards the brake disc 24 by the second spring 36b, urging the first movable plunger 28 against the brake disc 24. As a result, the brake disc 24 is in engagement with the first movable plunger 28 and with the first stationary element 22 similar to the first engaged state depicted in FIG. 4.

The engagement of the brake disc 24 brakes rotation of the brake disc 24 even in a situation in which the first movable plunger 28 does not move along the axial direction A with respect to the second movable plunger 30.

FIG. 6 illustrates a third engaged state of the elevator brake 20.

In the configuration illustrated in FIG. 6, the second movable plunger 30 did not move with respect to the second stationary element 32. The second solenoid 38a may still be activated and/or the second spring 36b may not be able to push the second movable plunger 30 away from the second stationary element 32.

In the configuration illustrated in FIG. 6, the first spring 36a pushes the first movable plunger 28 away from second movable plunger 30 towards the brake disc 24.

As a result, the brake disc 24 is in engagement with the first movable plunger 28 and the first stationary element 22, similar to the first engaged state depicted in FIG. 4. This engagement brakes rotation of the brake disc 24 even in a situation in which the second movable plunger 30 does not move along the axial direction A with respect to the second stationary element 32.

In an elevator brake 20 according to exemplary embodiments of the invention, the reliability of the elevator brake 20 is enhanced by providing two movable plungers 28, 30 that are movable independently of each other. As a result, the elevator brake 20 is capable to brake rotation of the brake disc 24 and the shaft 12 even in case one of the movable plungers 28, 30 does not move.

In an elevator brake 20 according to exemplary embodiments of the invention, first and second springs 36a, 36b are provided for urging the first and second movable plungers 28, 30 towards the brake disc 24 independently of each other. The movement of each of the movable plungers 28, 30, driven by the respectively associated spring 36a, 36b, alone is sufficient for reliably braking rotation of the shaft 12 and stopping the movement of the elevator car 6.

Since, according to exemplary embodiments of the invention, the first and second springs 36a, 36b are arranged and coupled in a serial configuration along the axial direction A, undesirable hard emergency stops of the elevator car 6 that may occur when conventional elevator brakes comprising two movable plungers are employed, may be prevented without deteriorating or even eliminating the required redundancy of the elevator brake 20.

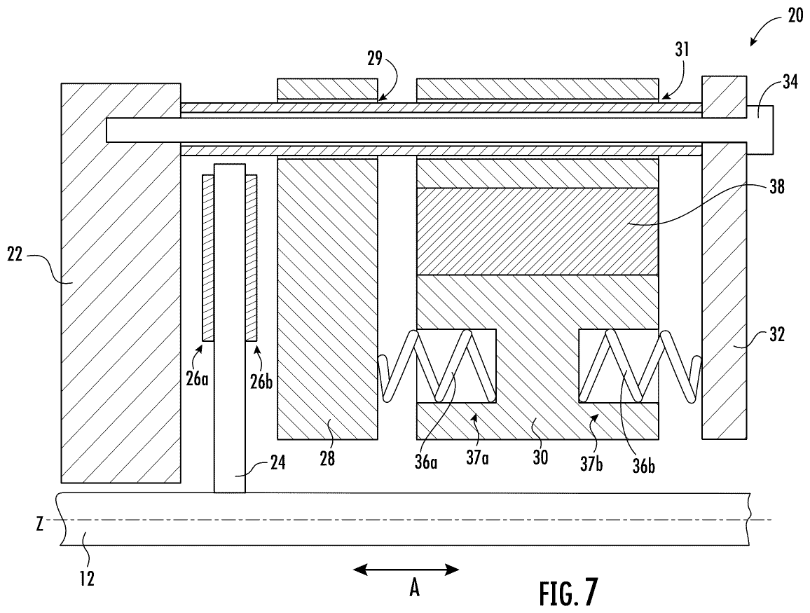

FIG. 7 depicts a schematic view of an elevator brake 20 according to another exemplary embodiment of the invention.

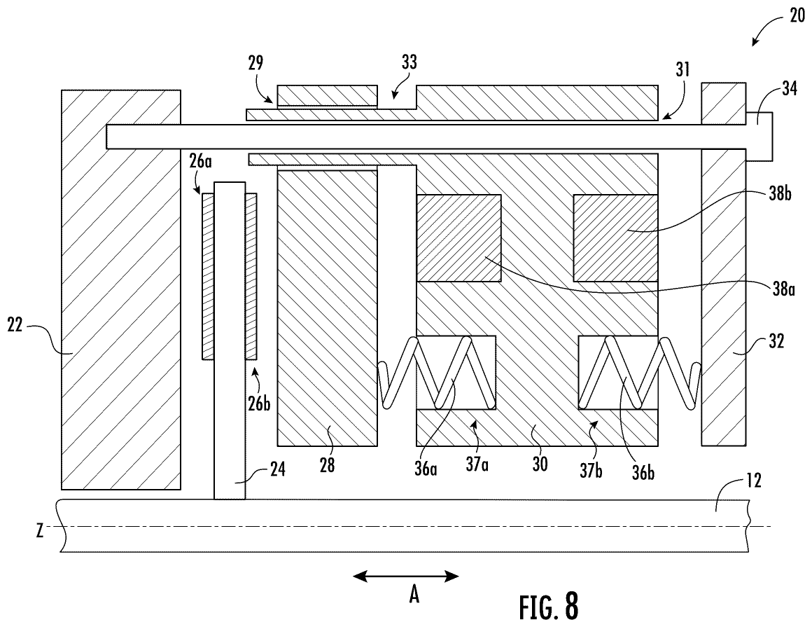

The features of the elevator brake 20 depicted in FIG. 7 that are identical with the features of the elevator brake 20 depicted in FIGS. 2 to 6 are denoted with the same reference signs and they are not discussed in detail again. The above description of the elevator brake 20 depicted in FIGS. 2 to 6 correspondingly applies to the features of the elevator brake 20 depicted in FIG. 8 except for the differences discussed in the following.

In the embodiment depicted in FIG. 7, the actuator of the elevator brake 20 comprises only a single coil 38 instead of two coils 38a, 38b. When activated, the single coil 38 generates a magnetic forces acting along the axial direction A attracting the first plunger 28 towards the second plunger 30 and simultaneously attracting the second plunger 30 towards the second stationary element.

FIG. 8 depicts a schematic view of an elevator brake 20 according to another exemplary embodiment of the invention.

The features of the elevator brake 20 depicted in FIG. 8 that are identical with the features of the elevator brake 20 depicted in FIGS. 2 to 6 are denoted with the same reference signs and they are not discussed in detail again. The above description of the elevator brake 20 depicted in FIGS. 2 to 6 correspondingly applies to the features of the elevator brake 20 depicted in FIG. 8 except for the differences discussed in the following.

Contrary to the embodiment depicted in FIGS. 2 to 7, in the embodiment depicted in FIG. 8 the first movable plunger 28 is not directly supported by the longitudinal support member 34. Instead, the first movable plunger 28 is supported by the second movable plunger 30 in a configuration that allows the first movable plunger 28 to move along the axial direction A with respect to the second movable plunger 30.

The second movable plunger 30 comprises an extension 35 that extends from the side of the second movable plunger 30 facing the first movable plunger 28 along the axial direction A parallel to the shaft 12 towards the first movable plunger 28. The extension 35 is formed coaxially with the second opening 31 provided within the second movable plunger 30.

The extension 35 extends through the first opening 29 formed within the first movable plunger 28. In consequence, the first movable plunger 28 is able to move along the axial direction A by sliding with the opening 29 along the extension 35.

The first and second movable plungers 28, 30 may both move in the axial direction A along the longitudinal support member 34 extending through the first opening 29 formed in the first movable plunger 28, through the second opening 31, and through the extension 35 formed at the second movable plunger 30.

The exemplary embodiment depicted in FIG. 8 may add additional reliability to the elevator brake 20. It may in particular prevent the first movable plunger 28 from blocking the second movable plunger 30 from moving towards the brake disc 24 in a situation in which the first movable plunger 28, in particular due to a malfunction, is not able to move along the axial direction A.

In the embodiment depicted in FIG. 8, even if the first movable plunger 28 is stuck on the extension 35 so that it is not movable with respect to the second movable plunger 30, the first movable plunger 28 is still able to move together with the second movable plunger 30 in the axial direction A, allowing the second movable plunger 30 to urge the first movable plunger 28 into engagement with the brake disc 24 for braking rotation of the brake disc 24.

In case the second movable plunger 30 is stuck on the longitudinal support member 34 preventing the second movable plunger 30 from moving along the axial direction A, the first movable plunger 28 is still able to move along the extension 35 towards the brake disc 24 for engaging with and braking rotation of the brake disc 24.

As a result, the first and second movable plungers 28, 30 are reliably prevented from blocking each other and the safety of the elevator brake 20 may be enhanced even further.

Although it is not explicitly shown in the figures, the embodiment of an elevator brake 20 depicted in FIG. 8 may be provided with only a single solenoid 38 for moving and holding both plungers 28, 30, as it is depicted in FIG. 7, as well.

While the invention has been described with reference to exemplary embodiments, it will be understood by those skilled in the art that various changes may be made and equivalents may be substituted for elements thereof without departing from the scope of the invention. In addition many modifications may be made to adopt a particular situation or material to the teachings of the invention without departing from the essential scope thereof. Therefore, it is intended that the invention shall not be limited to the particular embodiment disclosed, but that the invention includes all embodiments falling within the scope of the dependent claims.

What is claimed is:

1. Elevator brake (20) for braking rotation of a shaft (12) in an elevator drive system (5), the shaft (12) extending in an axial direction (A) and being rotatable around an axis of rotation (Z), the elevator brake (20) comprising:
at least one brake disc (24) mounted to the shaft (12) such as to rotate concurrently with the shaft (12);
at least two movable plungers (28, 30) that are movable along the axial direction (A) for engaging the elevator brake (20) or releasing the elevator brake (20); and
an actuator comprising:
at least two springs (36a, 36b), each spring (36a, 36b) being configured for applying a spring force to at least one of the at least two movable plungers (28, 30) for urging the at least one movable plunger (28, 30) towards the at least one brake disc (24) for engaging the elevator brake (20); and
at one solenoid (38; 38a, 38b) configured for producing a counterforce directed against the spring forces applied by the springs (36a, 36b) such as to urge the at least two movable plungers (28, 30) in the axial direction (A) away from the at least one brake disc (24) for releasing the elevator brake (20);
wherein the at least two springs (36a, 36b) are arranged in series with each other along the axial direction (A).

2. Elevator brake (20) according to claim 1, further comprising at least one longitudinal support member (34) extending parallel to the shaft (12),
wherein at least one of the at least two movable plungers (28, 30) is movably supported by the at least one longitudinal support member (34).

3. Elevator brake (20) according to claim 1, further comprising a first stationary element (22) not rotating with the shaft (12).

4. Elevator brake (20) according to claim 3,
further comprising a second stationary element (32) not rotating with the shaft (12),
wherein the at least one brake disc (24), the at least two movable plungers (28, 30) and the actuator including the at least two springs (36a, 36b) and the at least two solenoids (38; 38a, 38b) are arranged in between the first stationary element (22) and the second stationary element (32) along the axial direction (A).

5. Elevator brake (20) according to claim 3, comprising a single brake disc (24), a first movable plunger (28) and a second movable plunger (30), wherein the brake disc (24) is interposed in between the first stationary element (22) and the first movable plunger (28),
wherein the first movable plunger (28) is in particular configured for frictionally engaging with the brake disc (24) urging the brake disc (24) towards the first stationary element (22) for frictionally engaging the brake disc (24) with the first stationary element (22) in order to produce a braking force braking rotation of the brake disc (24) and the shaft (12) according to the frictional engagement.

6. Elevator brake (20) according to claim 5,
wherein the second movable plunger (30) comprises an extension (35) extending in the axial direction (A) from the second movable plunger (30) towards the brake disc (24), and
wherein the first movable plunger (28) is supported by the extension (35) such as to be movable along the axial direction (A) with respect to the second movable plunger (30).

7. Elevator brake (20) according to claim 1,
wherein the at least two springs (36a, 36b) include a first spring (36a) configured for exerting a spring force urging the first movable plunger (28) along the axial direction (A) towards the brake disc (24).

8. Elevator brake (20) according to claim 7,
wherein the at least two springs (36a, 36b) include a second spring (36b) configured for exerting a spring force urging the second movable plunger (30) away from the second stationary element (32) along the axial direction (A).

9. Elevator brake (20) according to claim 8, wherein the actuator comprises at least two solenoids (38a, 38b) each solenoid being associated with a respective one of the at least two springs (36a, 36b) and configured for producing a counterforce directed against the respective spring force applied by the spring (36a, 36b) such as to urge the respective at least one movable plunger (28, 30) in the axial direction (A) away from the at least one brake disc (24) for releasing the elevator brake (20).

10. Elevator brake (20) according to claim 9, wherein the at least two solenoids (38a, 38b) include a first solenoid (38a) associated with the first spring (36a) and configured for producing a counterforce directed against the spring force exerted by the first spring (36a) for attracting the first movable plunger (28) towards the second movable plunger (30).

11. Elevator brake (20) according to claim 10, wherein the first spring (36a) and the first solenoid (38a) are accommodated in the second movable plunger (30).

12. Elevator brake (20) according to claim 10, wherein the at least two solenoids (38a, 38b) include a second solenoid (38b) associated with the second spring (36b) and configured for producing a counterforce directed against the respective spring force exerted by the second spring (36b) for attracting the second movable plunger (30) towards the second stationary element (32) along the axial direction (A).

13. Elevator brake (20) according to claim 12, wherein the second spring (36b) and the second solenoid (38b) are accommodated in the second movable plunger (30).

14. Elevator drive system (5), comprising a rotatable shaft (12), a motor (9) for rotating the shaft (12) and an elevator brake (20) according to claim 1 for braking rotation of the shaft (12).

15. Elevator system (2) comprising:
an elevator car (6) that is movable in a hoistway (4) between a plurality of landings (8); and an elevator drive system (5) according to claim 14 that is configured for moving the elevator car (6) along the hoistway (4).
